(19) United States
(12) Patent Application Publication
(10) Pub. No.: US 2026/0248112 A1
(43) Pub. Date: Aug. 27, 2026

(54) AQUACULTURE DEVICE

(71) Applicant: SeaScale LLC, Thomaston, ME (US)

(72) Inventors: Charles Matthew Walsh, Thomaston, ME (US); Jonathan Brett Steuber, Tenants Harbor, ME (US)

(21) Appl. No.: 19/417,604

(22) Filed: Dec. 12, 2025

Related U.S. Application Data
(60) Provisional application No. 63/763,013, filed on Feb. 25, 2025.

(51) Int. Cl. A01K 61/55; A01K 61/30

(52) U.S. Cl. CPC A01K 61/55; A01K 61/30

(57) ABSTRACT

An aquaculture device designed to hold and secure marine species such as scallops, urchins, or oysters in an underwater environment while they grow, the device configured to be deployed and retrieved in a manner similar to conventional commercial fishing gear.

### BACKGROUND INFORMATION

### Field of the Invention

The invention is related to aquaculture devices, and in particular devices that are designed to hold and secure marine species such as scallops, urchins, or oysters, or clams, in an underwater environment while they grow.

### Discussion of Prior Art

Aquaculture is a rapidly growing industry that provides environmentally sustainable methods for cultivating marine species, such as scallops, oysters, urchins, and other shellfish. However, many of the existing aquaculture systems are designed for specialized operations, requiring significant investment in equipment, infrastructure, and expertise. These systems often operate in a manner that is disconnected from traditional fishing operations, which creates a barrier to entry for many, importantly including commercial fishermen, such as those in established industries such as lobster fishing, which should be natural fits for such systems and methods.

For example, one method of aquaculture farming is to use cages filled with marine organisms that sit on the floor of a body of water in order to allow the organisms to grow in a contained and protected environment. The conventional cages are deployed from boats with specialized equipment, which must be able to slowly and carefully lower the cages into the landing position in order for the cage to reliably land upright in anything more than a few feet of water. In general, bottom cages are bridled on top of the device with the bridle tied only into the wire, usually at the upper corners of the cage, which often causes deformation from the strain of lifting the cage out of the water, particularly when the marine organisms are reaching a large and/or fully grown size, the equipment becomes fouled, or has sunken into sediment. Such cages and bridles are also structured in a manner that cannot be trawled together to lift multiple cages at a time from a single line, such that each cage must be tended individually. The cages also require a form of feet or stilts on a bottom or underneath side of the cage in order to keep the organism from settling into the ocean floor as the cage settles over time. Lastly, while there are methods of aquaculture that grow organisms in a device that sits on the floor of a body of water or that is suspended in a body of water, there does not exist a device that is able to alternatively be suspended in the water or placed on the ocean floor for production purposes.

Meanwhile, lobstermen and other commercial fishermen typically use specialized boats and gear designed specifically for harvesting lobster. While the tools and equipment used by these fishermen are well-suited to their target species, they are not optimized for aquaculture practices. The integration of aquaculture techniques into commercial fishing operations could enable the cultivation of shellfish, providing an additional revenue stream for these fishermen, while contributing to the sustainable development of marine resources. However, this integration has been hindered by the incompatibility of conventional fishing traps with the requirements of aquaculture systems.

A conventional lobster trap, also known as a lobster pot, for example, is a widely used fishing device designed specifically for the capture of lobsters. The structure typically comprises a rectangular frame, which is typically made from a mesh wire to form the trap's walls. These traps often feature one or more entry points or “funnels” through which lobsters can enter the trap but cannot easily exit once inside. The entry funnels are designed with a narrow opening that allows lobsters to enter in search of bait, but the design of the trap ensures that once the lobsters are inside, they are unable to escape. In conjunction with these entry funnels, the traps also include rectangular braces inside the top of the trap running widthwise for structural support. These traps are commonly baited with fish or other attractants to lure the lobsters into the trap. The bait is typically placed in a central compartment or semi-centralized area, and the trap is designed to allow the lobsters to be drawn into it by the scent.

Once the trap has captured lobsters, it is hauled to the surface using ropes and mechanical winches on lobster boats. These traps are typically deployed in various locations along the seabed, with multiple traps being set in a line or “trawl.” The traps are tethered to buoys on the surface, which allow them to be easily located and retrieved. This system of using traps, often in combination with specialized boats, has been a staple of commercial lobster fishing for generations.

While effective for capturing lobsters, this general structure and approach have not been designed to support the cultivation of shellfish or integrate with aquaculture systems generally.

There remains a need for an aquaculture device that can be used in conjunction with existing commercial fishing gear, such as lobster traps, while offering the benefits of shellfish cultivation. Such a device would enable fishermen to engage in aquaculture without requiring substantial changes to their existing operations or additional investments in specialized equipment. Furthermore, this device should allow for the effective growth and harvesting of shellfish in a manner that supports sustainability and enhances the economic viability of commercial fishing enterprises.

The present invention addresses these needs by providing a novel aquaculture device that is configured to operate alongside conventional lobster traps and similar equipment. This device allows commercial fishermen to engage in aquaculture practices without the need for extensive modifications to their existing gear or vessels. By offering a more accessible and integrated approach to aquaculture, this invention holds the potential to enhance both the sustainability of marine resources and the financial stability of fishing communities.

### BRIEF SUMMARY OF THE INVENTION

The invention is an aquaculture device that is adapted to be placed on the floor of a body of water or suspended in a body of water, and that is configured to be deployed and retrieved using conventional commercial fishing gear, largely in the manner of a conventional lobster trap. More specifically, the aquaculture device is a cage-like structure that is configured to be deployed and retrieved in a manner similar to that of a conventional lobster trap, namely pushed off the side of a lobster boat while still reliably landing in the desired position, thus enabling fisherman who own or operate conventional lobster boats to easily and cost-effectively enter the aquaculture industry.

In a primary embodiment, the exterior of the device bears resemblance to a conventional lobster trap, likely made from a wire mesh and rectangular in shape, however, aside from the openings in the mesh the device is completely closed. One of the sides of the device, most likely a lengthwise side or a top area, includes a door that allows access to the inside of the device, while the other sides, the top, and the bottom likely remain fixed in a closed position. Other embodiments are also contemplated, such as those that have a cylindrical shape.

Inside the pot are one or more production bays, which include a shelf that is configured to hold shellfish bags and/or containers filled with marine organisms, or that may support and contain certain marine organisms directly. In terms of containers, when the door to the device is opened the production bays are configured to allow the containers to be easily removed and inserted so that the marine organisms within may be well tended in a convenient manner.

A lower bay has an opening in the middle that acts as a false bottom that serves multiple purposes. First, it provides an area of separation between the production bays that hold the marine organisms and the ocean floor. Second, this false bottom may also serve as a storage compartment, for example, it may be used to hold the ropes that are used to deploy the device when the device is out of the water and/or in transit or being stored. This false bottom may also secure removable weights, allowing for the user to add weight for setting pots in bottom culture, remove weight for suspended culture, or conduct maintenance on the device.

The device also incorporates a number of reinforcing components that are needed to provide the strength necessary to support the marine organisms in their respective bays, and also to support the overall structure of the device as it is retrieved and deployed, as the weight of the marine organisms that may become heavy as they grow, and to support the structure as it may endure harsh conditions while deployed in the ocean over time. These reinforcing components also allow for the device to be stacked and stored like a lobster trap without the internal rectangular bracing standard to the commercial lobster industry.

Additionally, the device includes a bridle and bridle braces, that are replaceable and interchangeable to bear the force of the bridle being hauled by a hydraulic hauler. More specifically, the device may be bridled from the top or either side or both without interfering with handling. The bridles enable a method of deploying and retrieving in trawls with either bridal orientation. And the bridals are reinforced to prevent deformation. Side braces are oriented vertically in corners and can be arranged on the left or right side of the device based on user preference.

Top braces are oriented horizontally in corners. This allows the device to be deployed in multiple configurations based on user preference.

Multiple bridling options allow for flexibility with different species. For example, some marine organisms like scallops and urchins will move themselves into a preferred position, while oysters and clams likely need to be distributed by the user. Both sides and top braces are made of the same materials. When the bridle is untied it can be removed and placed into the alternative position without tools.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a front view of the device according to the invention, filled with shellfish bags with the door closed and the rope for the bridle stored in the bottom bay.

FIG. 2 is a perspective view of the device shown in FIG. 1 showing the front and top.

FIG. 3 is a perspective view of the device shown in FIG. 1 showing the front, end, and top.

FIG. 4 is a front view of the device with the door open and the production bays filled with shellfish bags.

FIG. 5 is a front view of the device with the door open and the lowest production bay empty with rope stored in the bottom bay.

FIG. 6 is a front view of the device shown in FIG. 5 with the door open and the rope removed from the bottom bay.

FIG. 7 is a perspective view of the device with the door open and the production bays empty, showing the front and end of the device.

FIG. 8 is a bottom view of the device.

FIG. 9 is a perspective view of the device showing the front and top with a bridle secured to the top of the device.

FIG. 10 is a close up view of the bottom bay showing a support weight.

FIG. 11 is a perspective view showing the top, side, and an upper support.

FIG. 12 is a close up view of an upper support.

FIG. 13 is a perspective view of a second embodiment of the device that has a top opening an large bay.

FIG. 14 is a perspective view of the second embodiment holding shellfish bags.

FIG. 15 is a perspective view of the second embodiment with shellfish bins.

FIG. 16 is a perspective view of the three custom made shellfish bins for use with the device.

FIG. 17 is a front view of third embodiment where the device has a cylindrical shape with a top bridle.

FIG. 18 is a front view of the third embodiment with a side bridle.

FIG. 19 is a front view of the third embodiment showing a side opening with a stack of production bins being inserted.

FIG. 20 is a front view of the third embodiment showing a top opening with a stack of production bins being inserted

FIG. 21 is a front view of a set of stackable bins for use with the third embodiment.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

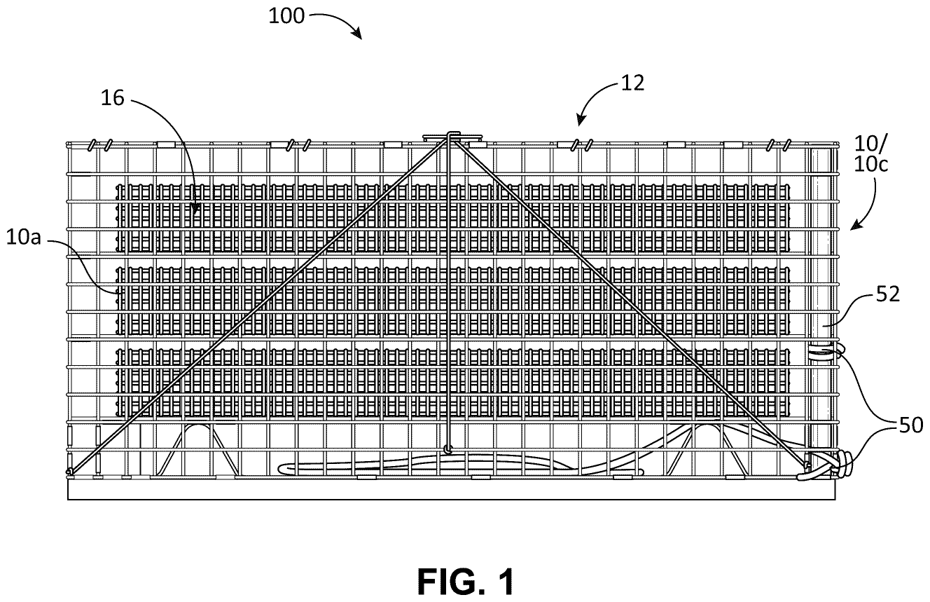

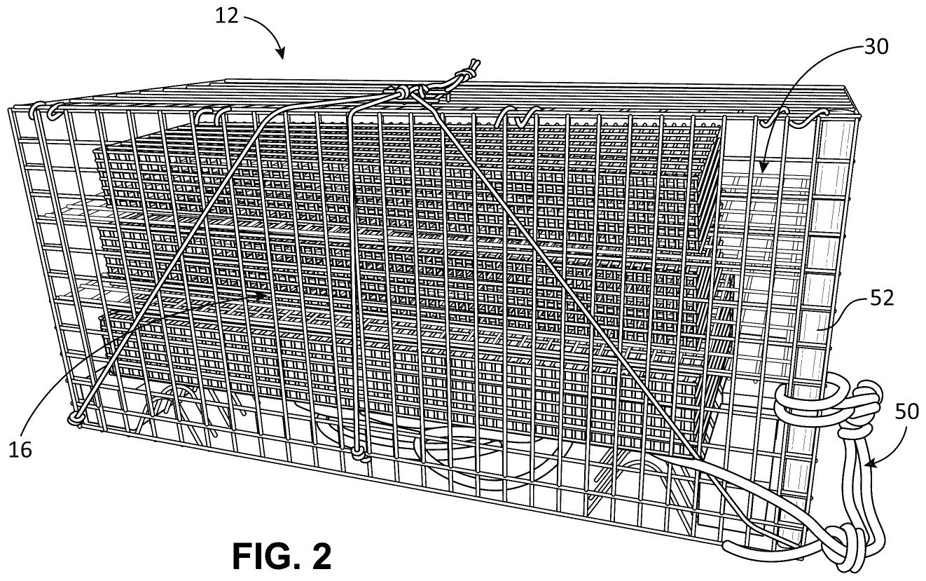

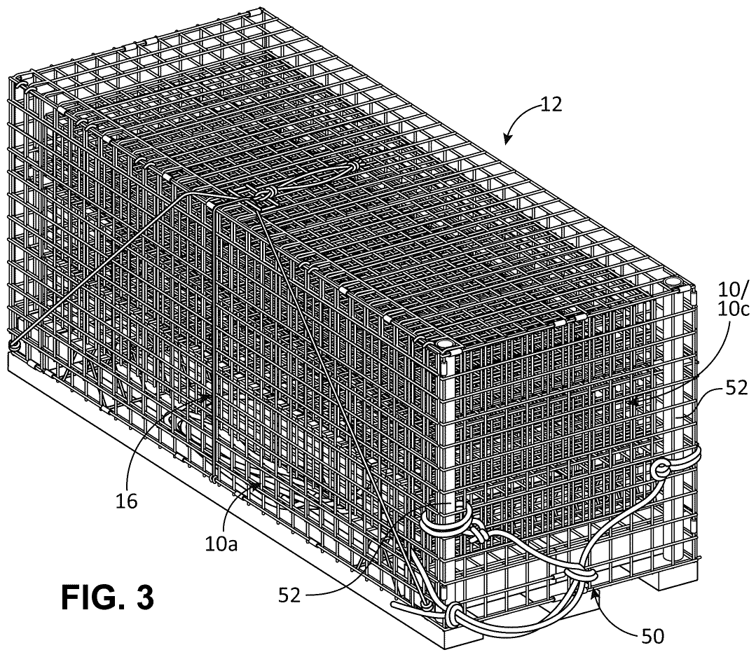

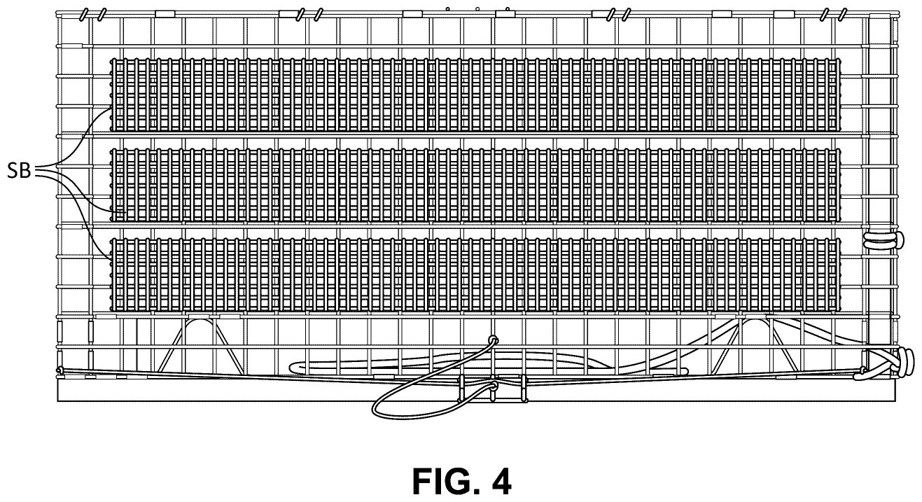

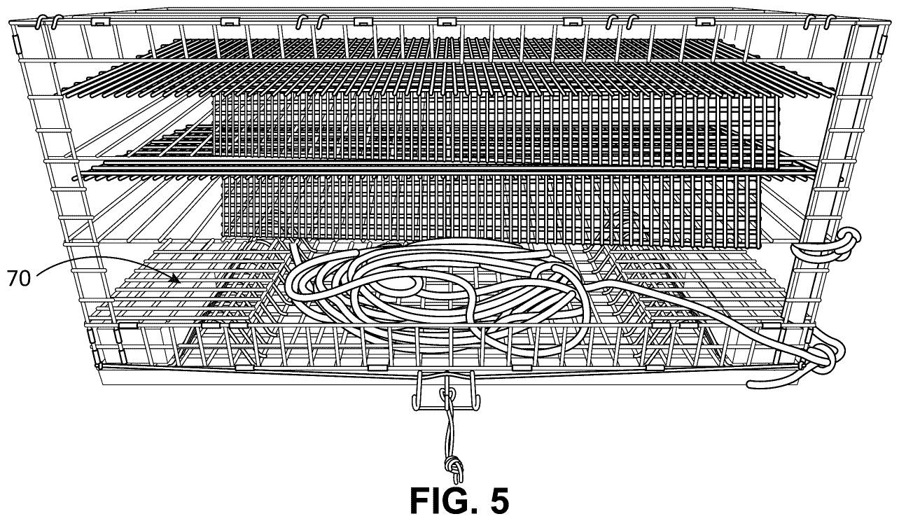

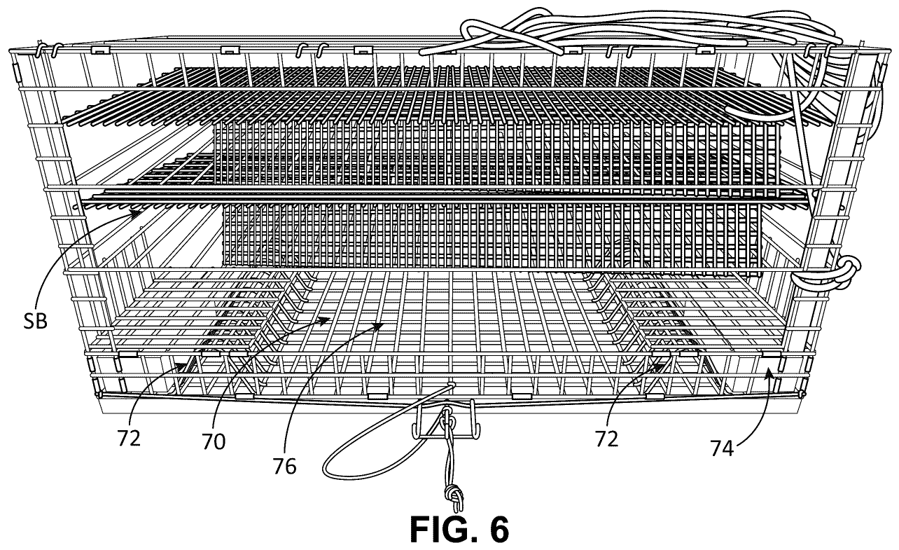

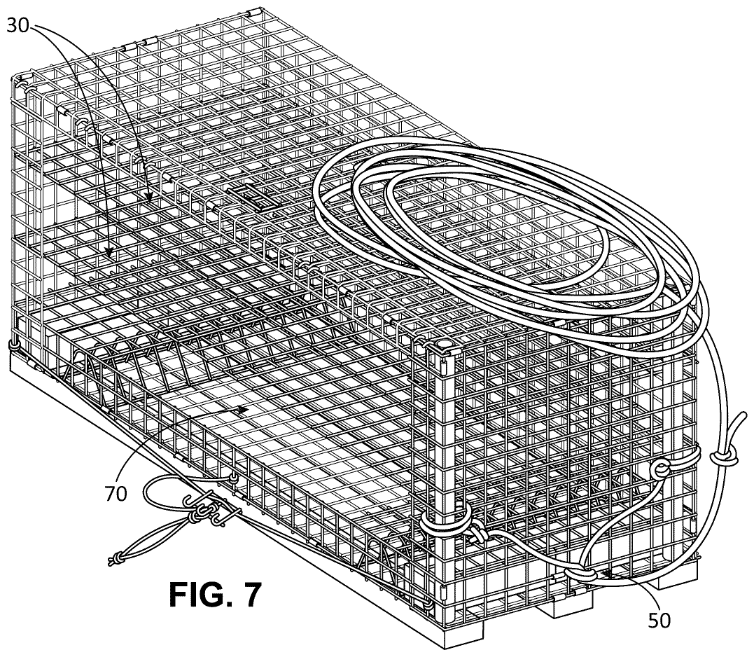

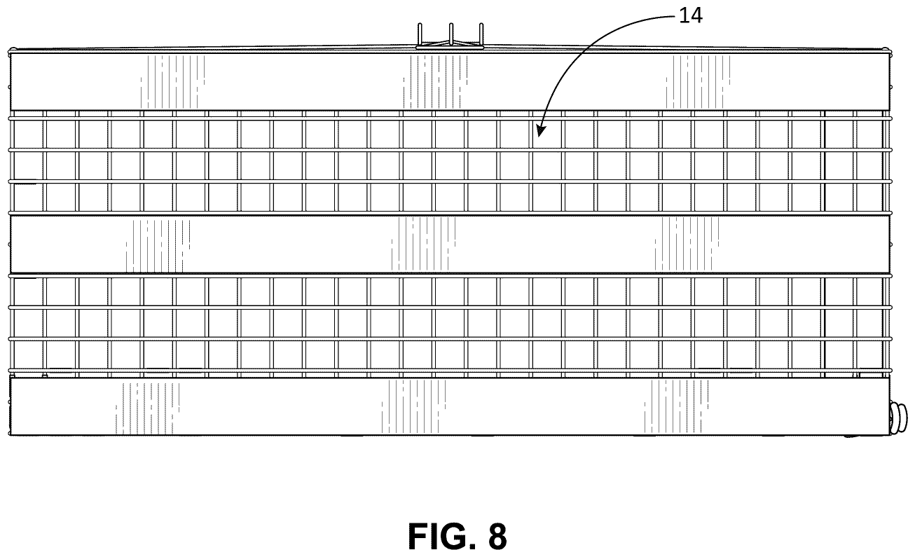

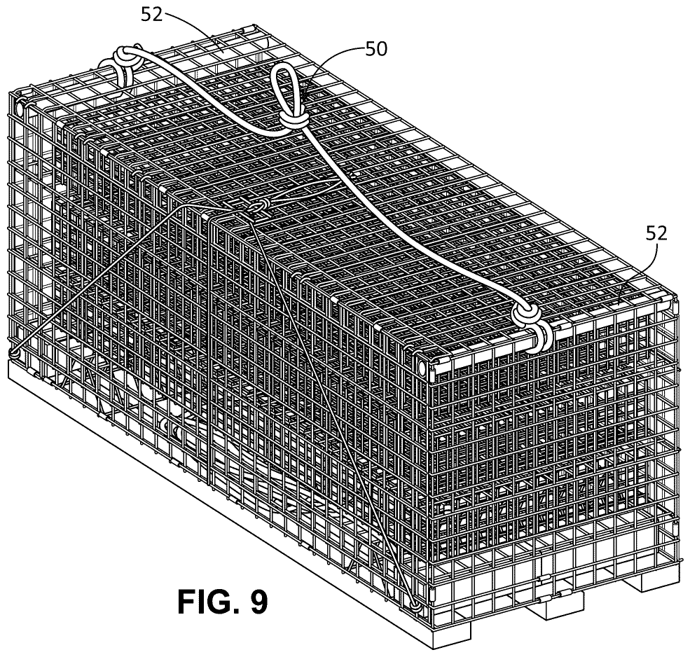

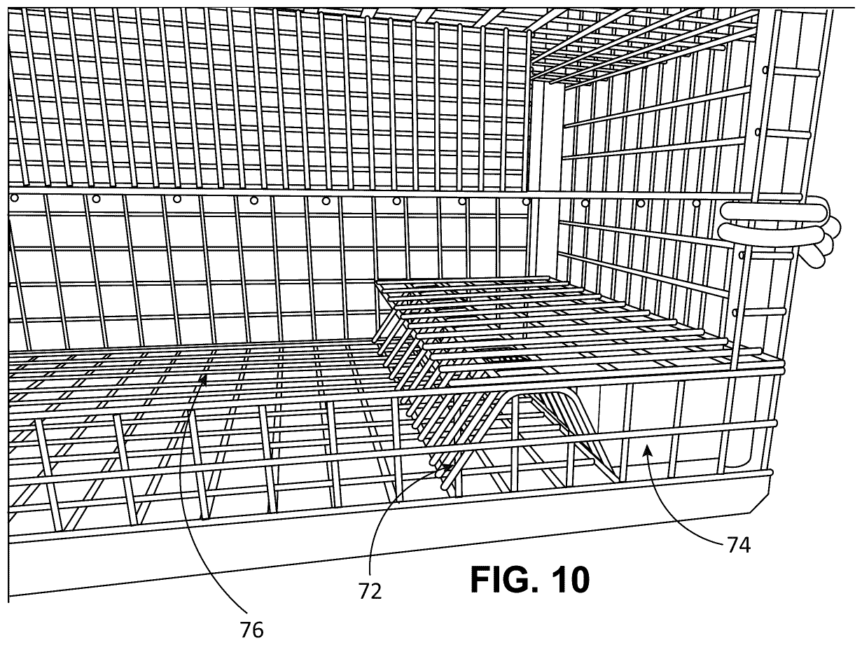

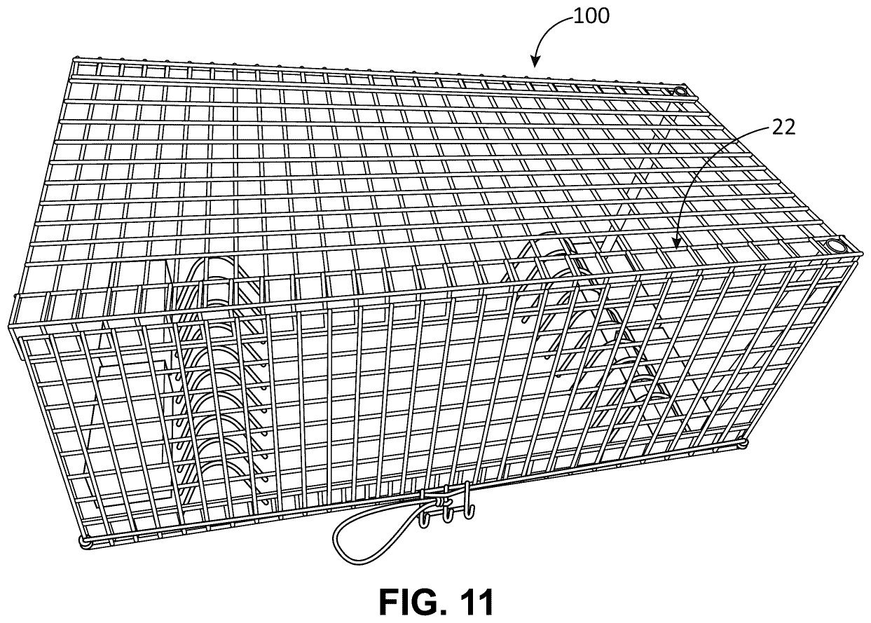

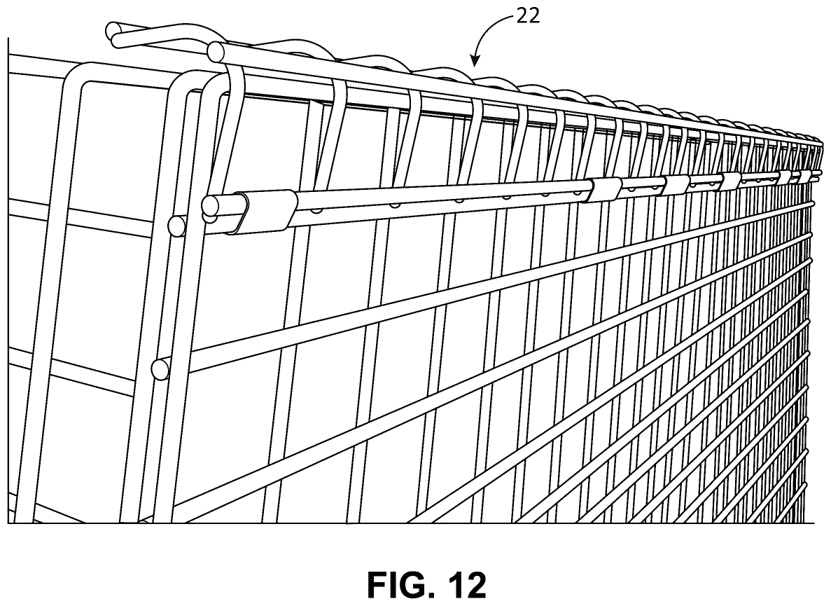

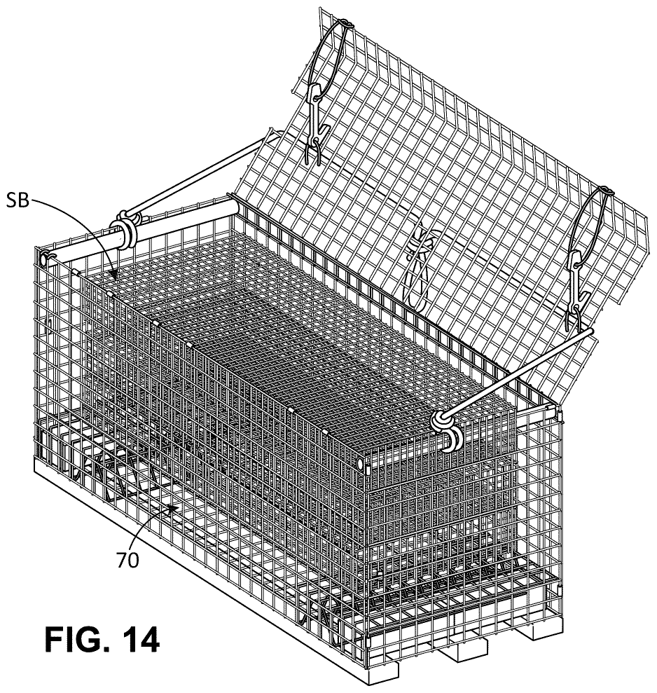

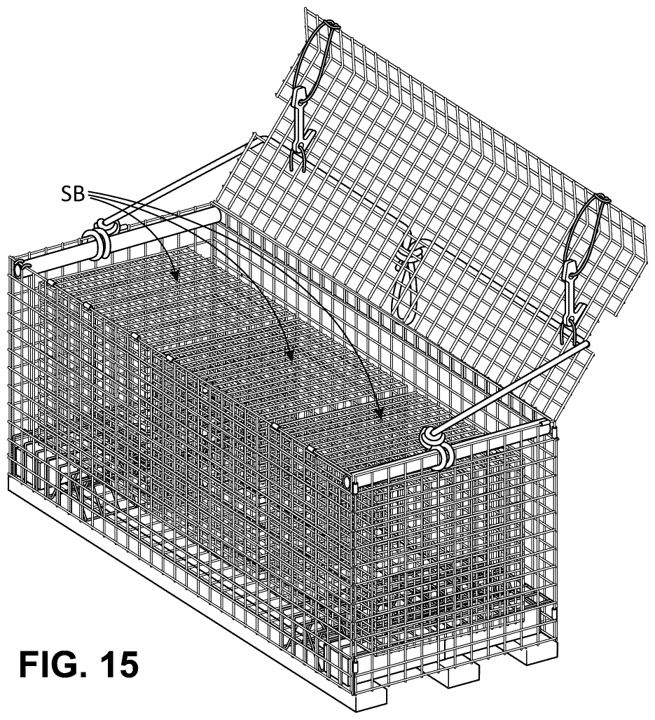

FIGS. 1-21 illustrate an aquaculture device 100 according to the invention. The device 100 includes sidewalls 10 a top 12 and a bottom 14 that combine to form a cage-like enclosure. At least one door 16 is provided to allow for operational access to the interior of the device 100. A bridle 50 is attached to the device 100. In use, the device 100 is filled with young bivalves, the bridle 50 is attached to a conventional line, and the aquaculture device 100 is deployed into a body of water with the line being accessible at the surface. In a common embodiment the device 100 is deployed and retrieved in a manner similar to that of a conventional lobster pot, where a commercial fishing boat one or more aquacultural devices 100 to a desired location, loads the device 100 with the bivalves, and then sets the device 100 off the boat to the ocean floor, with the line likely tied to a buoy at the surface.

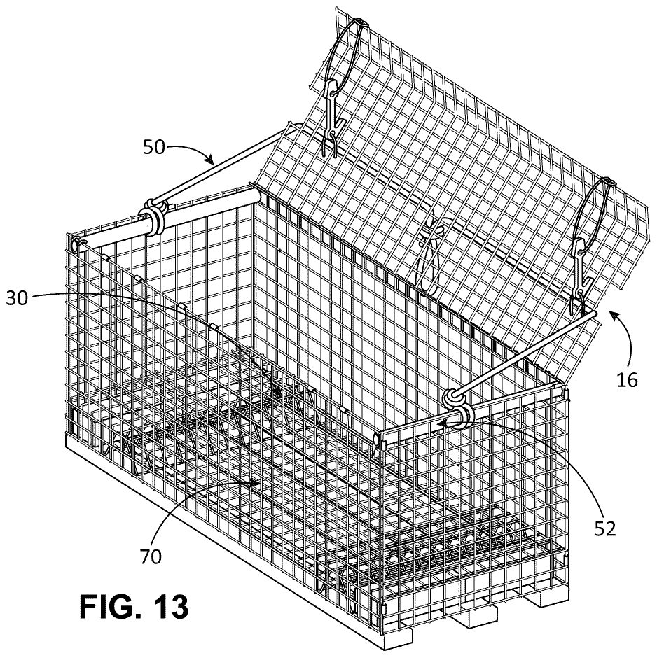

While multiple configurations are contemplated, the main embodiments of the device, illustrated FIGS. 1-16 , are rectangular in shape, having comparatively long sidewalls 10a, 10b, and comparatively shorter end walls 10 c, 10d. The door 16 may be positioned on one of the sidewalls 10a, 10b, which, when used with shellfish bags SB, allows the shellfish bags SB to be pulled or rotated out of the device widthwise, instead of lengthwise, which minimizes the working space necessary to empty and restock the device 100. The door 16 may also be positioned on the top of the device as shown in FIGS. 13-16.

FIGS. 1-12 illustrate a first embodiment of the device, which include an inner area where one or production bays 30 are located. The production bays are essentially horizontally arranged shelves 32 that are configured to support either marine organisms or a container that in turn is configured to support marine organisms.

The embodiment shown includes three production bays 30. Each bay 30 is configured as a horizontal shelf that extends from between each end wall and each side wall is able to support shellfish bags, other similarly structured containers, and or marine organisms directly on the shelves. Again, in the case of shellfish bags and the door 16 in the sidewall 10a, 10b, the shellfish bags may be removed widthwise from the production 30 or rotated out of position, allowing the user to empty or fill the devices without needing a great deal of space on the fishing vessel.

The production bays 30 are constructed in a vertical arrangement with one bay on top of another with sufficient space between the bays 30 to allow for storage of the bags. At the bottom of the device 100 is a bottom bay 70, which is configured as a false bottom and is generally not configured to support a shellfish bag or marine organisms as are the production bays 30. Rather, the bottom bay 70 is configured as a false bottom that keeps the marine-organisms supporting production bays 30 elevated above the ocean floor to prevent them from coming into contact with the sediment and provide a ideal opportunity for water to flow under and around all of the production bays, which provides a better environment for the marine organism relative to one where they are on or in the sediment.

The bottom bay 70 includes reinforcements 72 that help absorb and distribute the force of impact from the device 100 hitting the bottom after falling through the water column. As the device 100 is designed to be deployed and retrieved in a manner similar to a lobster trap, which is not designed to support the additional weight of animals when set back onto the ocean floor, the inventive device 100 requires these internal braces to prevent the cage from deforming on impact.

The reinforcements 72 are anchored to both sides of the device 100 and the true floor of the device.

The bottom reinforcements 72 also make up the wall of separation between weight storage compartments 74 and a rope storage compartment 76. The weight storge compartments 74 enclose weights and keep them stable during deployment, the weights subsequently helping to hold the device 100 in a given location on the ocean floor.

More specifically, the rope compartment 76 is empty when deployed, which allows for water to flow underneath the production bays. When the device 100 is being stored, or transported, a coil of rope that may be attached to its bridle 50 may be placed in the compartment 76. This allows for rapid deployment, needing only to attach a buoy to set the transported device, much like a lobster trap.

The weight compartments 74 hold weights in a box on either side of the device 100. These weights, currently four bricks, ensure that the device lands upright and does not tip over. A combination of the device's 100 relatively small size and weight distribution are key to this and conventional devices that are larger both in width and height are unable to be set into deep water without being lowered onto the bottom and are also prone to tipping over in high flow environments.

A top portion of the weight compartment also acts as the bottom of a production bay 30 shelf. The shelf may also have attachment points that allow it to open and close, for example, to replace or change weights and/or to make repairs. For example, J-Clips may be used on the side to act as hinge, with a zip tie or bungee attachments to hold it closed. Accessing this compartment and removable weights leads to better access to fasteners for replacing runners. The weights may also be removed in order to reduce the total weight of the device 100 when the device is used in a suspended culture configuration.

The device 100 also includes upper reinforcing members 22. These members 22 are rigid structural reinforcements horizontally placed along the outside device, on the lengthwise top edges of the device 100. These reinforcements are styled after edge protectors, and are designed to replace the rectangular braces within a lobster trap, making the top of the device structurally rigid and strong enough to be stacked without deforming.

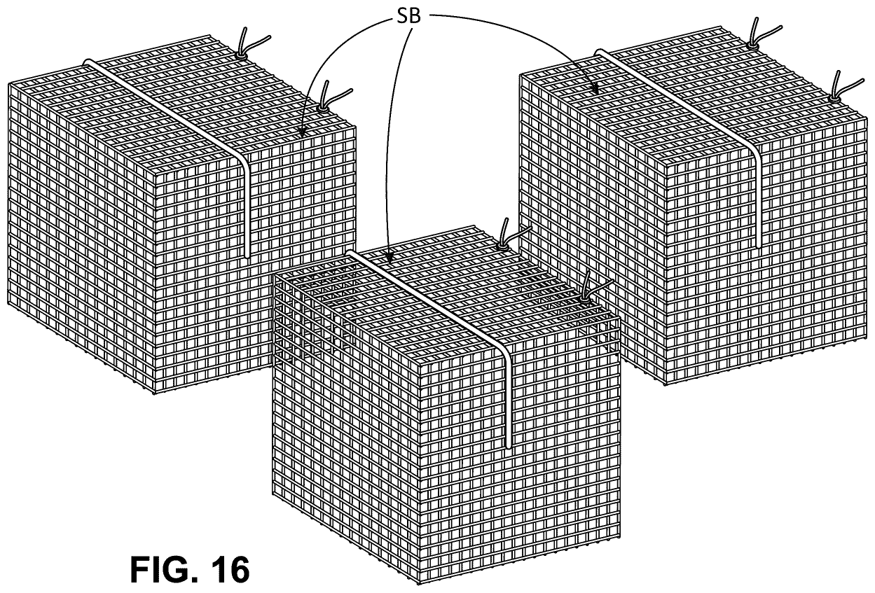

FIGS. 13-16 illustrate the second embodiment that is similar in shape but that has the door 16 on the top portion of the device 100. The inside of the device is largely open down to the bottom bay 70, which is still provided as in the first embodiment. This embodiment also may include larger bins SB, illustrated in FIG. 16. These larger bins SB may be appropriate for bivalves as they grow and need more space, and/or they may also be more advantageous for a species such as urchins that require food such as kelp. In the later case, the container SB may, for example, be opened from the top after which kelp may be placed inside for the urchins to eat, after which the device 100 may be redeployed. In the embodiment shown, the bins are made of mesh wire with a door on the top that is opened, closed, and secured much in the manner of a conventional lobster trap.

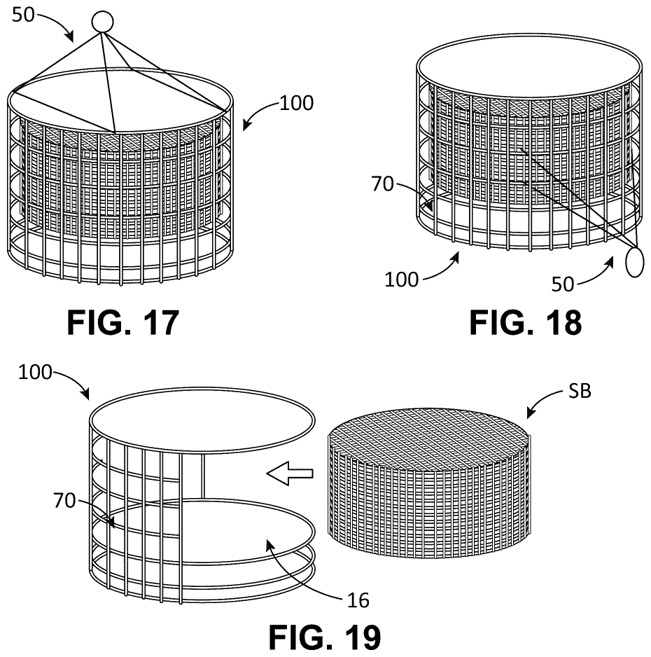

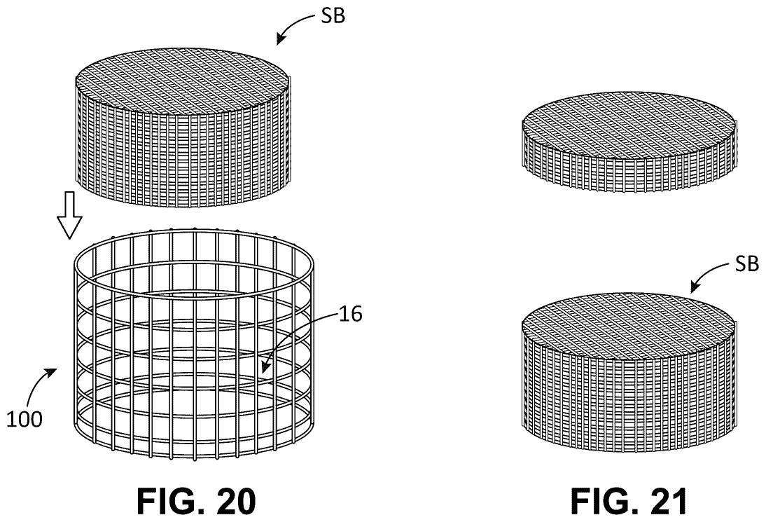

FIGS. 17-21 illustrate another embodiment, which has similar features and similar functions as those shown in FIGS. 1-16 , but in which the device has a largely cylindrical shape. FIGS. 17-19 illustrate an embodiment that is cylindrical in shape with a door on the side, and the same production bays 30 and bottom bay 70 shown in the earlier embodiment. Meanwhile FIG. 20 illustrates a cylindrical embodiment with a top opening. FIG. 21 illustrate stackable bins that function like the bags SB but that are shaped for use with this embodiment. They may be inserted into individual production bays or stacked and placed in a larger open area.

The bridle 50 may also be configured in multiple manners, which are replaceable and interchangeable, and which are adapted to bear the force of the bridle being hauled by a hydraulic hauler. The different adaptations enable the device to be deployed in multiple configurations based on user preference. To enable this, side braces 52 are oriented vertically in corners and may be arranged to left or right side of the device 100 based on user preference. Top braces 52 are oriented horizontally in corners. More particularly, multiple bridling options allow for flexibility with different species. For example, animals like scallops and urchins will move themselves into a preferred position, while oysters and clams need to be distributed by the user. In general, it is likely that both side braces 52 and top braces 52 are the similar dimensions, with the length varying to span the area, and made of the same materials. When the bridle is untied they can be removed and placed into the alternative position without tools.

The top bridle 50 may also be used to attach a buoyancy device. For example, when setting into deep water or high flow environments a user may choose to add a buoyancy aid to ensure that the device lands upright. In this situation the top bridle 50 may be used to attach a buoy or other float to help correctly orient the device 100. As the device 100 falls through the water column, both the weights and buoy will be acting upon the device to keep it upright. In this deployment scheme the recovery line may be attached to the top bridle 50, or the device 100 may utilize both bridling positions simultaneously, and the side bridle 50 may be used for the recovery line.

As noted, the device 100 may be deployed to sit on the bottom of a body of water, but may also be suspended in the water column. When bridled from the top the device 100 may be hung at the desired depth like a lantern net or dark sea tray. The weights may be removed to reduce the total weight of the device when deployed in this manner. The device 100 may also rapidly be deployed into bottom culture from suspended culture and vice versa with no tools needed.

Multiple devices 100 may be attached to a single recovery line, similar to the manner in which lobster traps may be trawled together using the side bridle, or the top bridle depending on preference. Recovery lines may be attached to either or both sides of the trawl.

Multiple devices 100 may also be trawled together for suspended culture. Using the top bridle, several devices may be tied into the same vertical line at a spacing of the user's choice. In this instance, the devices hang like a string of pearls from a longline or raft. This may also be used to seasonally take advantage of more productive parts of the water column, avoid predation, or store animals for easy access.

It is understood that the embodiments described herein are merely illustrative of the present invention. Variations in the aquaculture device may be contemplated by one skilled in the art without limiting the intended scope of the invention herein disclosed.

What is claimed is:

1: An aquaculture device comprising:
A cage-like enclosure having sidewalls, a top, and a bottom that define an interior space;
at least one door providing operational access to the interior space; One or more production bays located within the interior space, each production bay comprising a horizontally arranged shelf configured to support marine organisms or containers holding marine organisms;
a bottom bay positioned below the production bays and configured as a false bottom to elevate the production bays above an ocean floor; A bridle attached to the cage-like enclosure and configured to enable deployment and retrieval of the device using conventional commercial fishing gear;
and reinforcing components configured to support the marine organisms and the overall structure of the device during deployment and retrieval.

2: The aquaculture device of claim 1, wherein the cage-like enclosure has a rectangular shape with comparatively long sidewalls and comparatively shorter end walls.

3: The aquaculture device of claim 2, wherein the at least one door is positioned on one of the long sidewalls to allow containers to be removed widthwise from the production bays.

4: The aquaculture device of claim 1, wherein the cage-like enclosure has a cylindrical shape.

5: The aquaculture device of claim 1, wherein the at least one door is positioned on the top of the cage-like enclosure.

6: The aquaculture device of claim 1, comprising three production bays arranged vertically with sufficient space between the bays to allow for storage of containers.

7. The aquaculture device of claim 1, wherein the bottom bay comprises:
reinforcements configured to absorb and distribute force of impact from the device hitting the ocean floor;
weight storage compartments configured to hold weights and keep them stable during deployment; and
a rope storage compartment configured to hold coiled rope when the device is being stored or transported.

8. The aquaculture device of claim 7, wherein the weight storage compartments hold weights that ensure the device lands upright and does not tip over.

9. The aquaculture device of claim 7, wherein the weights are removable to reduce total weight of the device when used in a suspended culture configuration.

10. The aquaculture device of claim 1, further comprising upper reinforcing members positioned horizontally along lengthwise top edges of the device and configured to make the top of the device structurally rigid.

11. The aquaculture device of claim 1, wherein the bridle comprises interchangeable braces that are replaceable and configured to bear force of the bridle being hauled by a hydraulic hauler.

12. The aquaculture device of claim 11, wherein the interchangeable braces comprise:
side braces oriented vertically in corners and arrangeable on left or right sides of the device based on user preference; and
top braces oriented horizontally in corners.

13. The aquaculture device of claim 12, wherein the side braces and top braces have similar dimensions and are made of the same materials, and can be removed and placed into alternative positions without tools when the bridle is untied.

14: The aquaculture device of claim 1, wherein the device is configured to be deployed to sit on the bottom of a body of water or to be suspended in a water column.

15: The aquaculture device of claim 14, wherein when bridled from the top, the device can be hung at a desired depth like a lantern net.

16: The aquaculture device of claim 1, wherein multiple devices can be attached to a single recovery line for trawling together.

17: The aquaculture device of claim 1, wherein the production bays are configured to support shellfish bags that can be removed widthwise from the production bays when the door is positioned on a sidewall.

18. The aquaculture device of claim 1, wherein the device is configured to be deployed and retrieved in a manner similar to a conventional lobster trap by being pushed off the side of a boat while reliably landing in a desired position.

19. A method of aquaculture comprising:
providing the aquaculture device of claim 1;
Loading the production bays with marine organisms or containers holding marine organisms;
Deploying the device into a body of water using conventional commercial fishing gear; and
Retrieving the device using the bridle and conventional commercial fishing gear.

20. : The method of claim 19, wherein multiple aquaculture devices are attached to a single recovery line and deployed together in a trawling configuration.
